(19) United States
(12) Patent Application Publication
(10) Pub. No.: US 2009/0077924 A1
(43) Pub. Date: Mar. 26, 2009

(54) Methods of manufacturing engineered wood products

(75) Inventors: Kenneth Kwok-Cheung Lau, Vancouver (CA); Christopher Clement Serbyn, Grand Rapids, MN (US); Roger Lyle Summers, Ely, MN (US)

Correspondence Address: KOLISCH HARTWELL, P.C., 200 PACIFIC BUILDING, 520 SW YAMHILL STREET, PORTLAND, OR, 97204, US

(73) Assignee: Ainsworth Lumber Co., Ltd.

(21) Appl. No.: 11/974,971

(22) Filed: Oct. 16, 2007

Related U.S. Application Data
(60) Provisional application No. 60/994,814, filed on Sep. 21, 2007.

(51) Int. Cl. B27N 3/04

(52) U.S. Cl. 52/745.19; 52/309.1

(57) ABSTRACT

Methods for manufacturing an engineered wood product are disclosed. The method may include applying at least one preservative on the plurality of wood pieces; applying at least one resin on the plurality of wood pieces, wherein at least one of applying at least one preservative and applying at least one resin is configured to prevent interference among the at least one preservative and the at least one resin; forming a blanket of wood pieces from the plurality of wood pieces; and curing the at least one resin.

### CROSS-REFERENCE TO RELATED APPLICATIONS

This application claims priority under 35 U.S.C. § 119(e) to U.S. Provisional Patent Application Ser. No. 60/994,814 entitled “Methods of Manufacturing Engineered Wood Products,” filed Sep. 21, 2007. The complete disclosure of the above application is herein incorporated by reference for all purposes.

### BACKGROUND OF THE DISCLOSURE

Engineered wood products have become more popular because those products typically make better use of available forest resources. For example, products may be produced from smaller and lower quality trees, as compared to conventional wood products. Engineered wood products have been used in several applications, such as panels, boards, timber, beams, headers, columns, studs, wood I-joists, and various other applications.

Engineered wood products typically are manufactured by bonding together wood strands, veneers, lumber, particles, fines, and/or other forms of wood pieces to produce a larger composite material. Wood pieces may be blended with one or more resins, arranged in particular configuration(s), and then exposed to elevated temperatures, elevated pressures, and/or radiant energy to cure the resins. To provide for products that are resistant to fire and/or resistant to pests, such as termites and/or fungus, one or more preservatives and/or additives may be applied to the wood pieces during any suitable step(s) in the manufacturing process. For example, the wood pieces may be blended with one or more preservatives prior to those pieces being arranged in particular configuration(s).

The application of preservatives may, however, prevent the resins from curing. For example, the preservatives may have limited solubility in the resins. Additionally, or alternatively, the preservatives may modify one or more properties of the resins. For example, the preservatives may decrease the resin's pH, viscosity, cure speed and/or crosslink density, and/or may increase the resin's gel time. Alternatively, or additionally, the preservatives may prevent proper distribution of the resin during blending. Particular preservatives may be used that are compatible with the particular resins used. Alternatively, the manufacturing process may be optimized in one or more other ways to minimize incompatibility between the preservatives and the resins.

Examples of manufacturing processes are provided in U.S. Pat. Nos. 7,163,974; 7,008,684; 6,818,317; 6,811,731; 6,800,352; 6,767,490; 6,416,789; 6,403,000; 6,136,408; 6,098,679; 6,030,562; 5,718,786; 5,525,394; 5,470,631; 5,443,894; 5,425,976; 5,379,027; 4,364,984; 4,893,415; 4,879,083; 4,751,131; 4,517,147; 4,364,984; 4,361,612; 4,198,763; 4,194,296; 4,068,991; 4,061,819; 4,058,906; 4,017,980; 3,811,200; 3,685,959; 3,308,013; 3,173,460; 3,164,511; 3,098,781; 2,343,740; and 1,023,606; U.S. Patent Application Publication Nos. 2007/0122644; 2007/0120284; 2007/0077445; and 2006/0145383; and European Patent No. 0172930. The complete disclosures of those patents and patent applications are herein incorporated by reference for all purposes.

### SUMMARY OF THE DISCLOSURE

Some embodiments provide a method for manufacturing an engineered wood product. In some embodiments, the method may include applying at least one preservative on the plurality of wood pieces; applying at least one resin on the plurality of wood pieces, wherein at least one of applying at least one preservative and applying at least one resin is configured to prevent interference among the at least one preservative and the at least one resin; forming a blanket of wood pieces from the plurality of wood pieces; and curing the at least one resin.

In some embodiments, the method may include applying a mixture of at least one preservative and wax on one or more first portions of the plurality of wood pieces; applying at least one resin on one or more second portions of the plurality of wood pieces; orienting the plurality of wood pieces to form a blanket of oriented pieces; and curing the at least one resin.

In some embodiments, the method may include mixing at least one preservative and wax to form a mixture of at least one preservative and wax; applying the mixture of at least one preservative and wax as droplets on one or more first portions of the plurality of wood pieces; applying at least one of a PF resin and a MDI resin as droplets on one or more second portions of the plurality of wood pieces, wherein at least most of the one or more second portions are different from the one or more first portions; orienting the plurality of wood pieces to form a blanket of oriented pieces; and curing the at least one of a PF resin and a MDI resin

### BRIEF DESCRIPTION OF THE DRAWINGS

FIG. 1 is a flow diagram of an example of a method of manufacturing engineered wood products.

FIG. 2 is a more detailed flow diagram of the method of FIG. 1.

FIG. 3 is a partial schematic diagram of a wood piece after one or more steps of the method of FIG. 1, showing portions of the wood piece with preservative and portions of the wood piece with resin.

FIG. 4 is a block diagram of a blender and chemical assembly that may be used to practice the method of FIG. 1.

FIG. 5 is a schematic diagram of a rotary blender, which may be part of the blender assembly of FIG. 3.

FIGS. 6-7 are flow diagrams of other examples of a method of manufacturing engineered wood products.

FIG. 8 show images of a wood piece showing portions of the wood piece with wax and preservative, and portions of the wood piece with resin.

### DETAILED DESCRIPTION OF THE DISCLOSURE

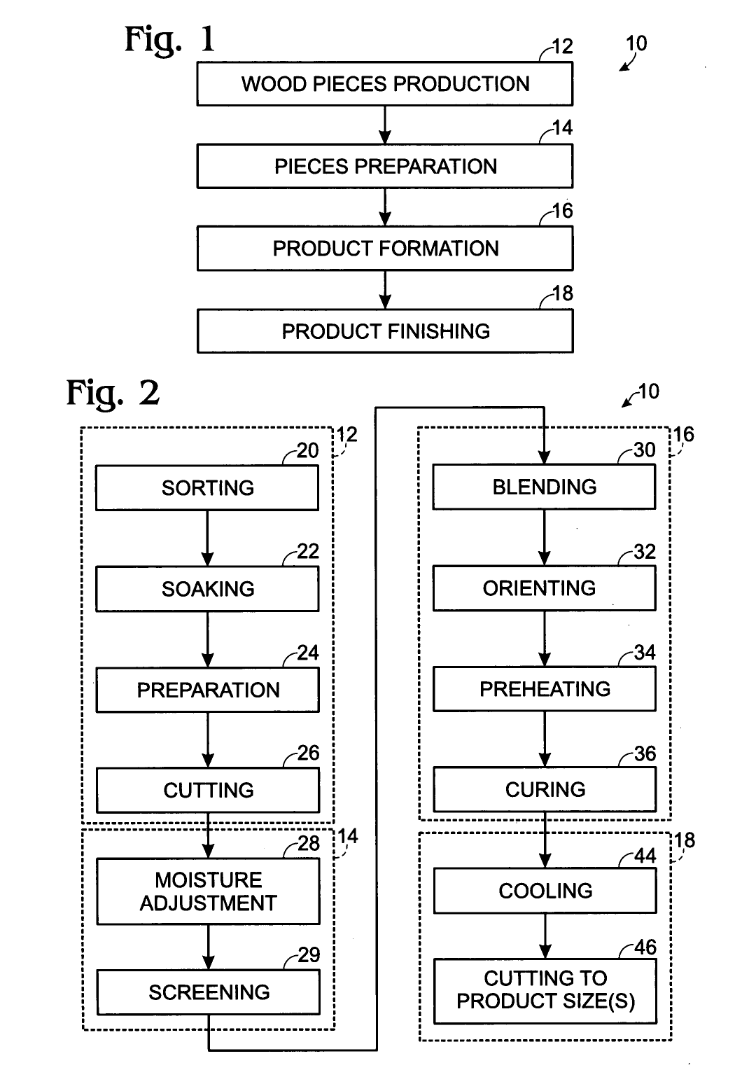

FIGS. 1-2 provide an example of a method for manufacturing engineered wood products, which is generally indicated at 10. The method may include any suitable steps configured to manufacture one or more types of engineered wood products. For example, method 10 may include the steps of wood pieces production at 12, pieces preparation at 14, product formation at 16, and product finishing at 18. The steps may be performed in different sequences and in different combinations, not all steps being required for all embodiments of method 10.

Wood pieces production at 12 may include one or more steps configured to produce the desired type of wood pieces from wood raw material(s), such as from any suitable type(s) of species of logs. For example, wood pieces production may include the steps of sorting at 20, soaking at 22, preparation at 24, and cutting at 26. The step of sorting may be configured to sort usable raw material(s) from unusable raw material(s). For example, log sorters may be used to sort out usable logs from unusable logs.

The step of soaking may be configured to soak raw material(s) to device, heat, and/or prepare the wood, such as when the logs are below about 50° F. For example, logs may be heated in soaking or thaw ponds and/or via any suitable structure or equipment. The soaking or thaw pond(s) may be at any suitable temperature(s). For example, the logs may be heated in a pond of water having a temperature of up to about 176° F., up to about 140° F., or up to about 104° F. Specifically, the logs may be heated in the thaw pond having a temperature of about 86° F. to about 110° F. Additionally, the logs may be heated for more than about one hour. Specifically, the logs may be heated for about one hour to about forty-eight hours.

The step of preparation may be configured to prepare raw material(s) for the step of cutting, such as removing unusable parts of the raw material(s). For example, logs may be debarked in any suitable debarker(s), such as ring and drum debarkers. The step of cutting may be configured to cut or slice the prepared raw material(s) into the desired wood pieces. Flakers (such as disk flakers and ring flakers), stranders, and/or any other suitable equipment may be used to perform the step of cutting. As used herein, “wood pieces” may include flakes, strands, veneers, pieces, fines, and/or any suitable pieces sliced or otherwise cut from wood raw material(s), such as logs.

The wood pieces may be any suitable size(s). For example, when the desired wood pieces are flakes for strand-based products, then those flakes may have lengths (y-dimension) of up to about 12 inches or about 4.5 inches to about 6.0 inches, and may have widths x-dimension) of up to about 12 inches or about 0.25 inches to about 2.5 inches. Similarly, those flakes may have a thickness (z-dimension) of about 0.001 inches to about 0.060 inches, or about 0.020 inches to about 0.030 inches. The width of the flakes may be a function of the length of the flakes. For example, the length of the flakes may be at least about three times greater than the width of the flakes, which may provide for proper flake orientation and acceptable physical properties for the engineered wood product.

Additionally, if the desired pieces are strands for OSL or LSL billets, then those strands may have lengths (y-dimension) of about 6 inches or about 0.5 inches to about 7 inches, and may have widths x-dimension) of about 1 inch or about 0.04 inches to about 2.5 inches. Similarly, those strands may have a thickness (z-dimension) of about 0.031 inches, or about 0.01 inches to about 0.08 inches. The width of the strands may be a function of the length of the strands. For example, the length of the strands may be at least about three times to at least about six times greater than the width of the flakes. ASTM D5456-05 (sections 3.2.2.1 and 3.2.2.3), the complete disclosure of which is herein incorporated by reference for all purposes, defines LSL and OSL as a composite of wood strand elements with wood fibers primarily oriented along the length of the member with a least dimension (such as the lesser of a thickness or a width) of the strands of LSL and OSL not to exceed 0.10 inches. The average length of LSL shall be a minimum of 150 times the least dimension, and the average length of OSL shall be a minimum of 75 times the least dimension.

Although the wood pieces are described to have certain dimension ranges, those wood pieces may have any suitable dimensions. For example, wood pieces may alternatively, or additionally, include one or more fines. Additionally, although the step of wood pieces production is described to have certain steps, the step of wood pieces production may include any suitable steps configured to produce the desired type of wood pieces from raw material(s), such as from any suitable type(s) of species of logs. Moreover, the steps discussed above may be performed in different sequences and in different combinations, not all steps being required for all embodiments of method 10.

The step of pieces preparation at 14 may include one or more steps configured to prepare the wood pieces for producing the engineered wood product(s). For example, the step of pieces preparation may include the step of moisture adjustment at 28 and screening at 29. Any suitable dryer(s) may be used for the step of moisture adjustment, such as a tumble dryer, triple-pass dryer, a single-pass dryer, a combination triple-pass/single-pass dryer, and/or a three-section conveyor. Another example of a suitable dryer is one in which the wood pieces are laid on a chain mat and the wood pieces are held in place as they move through the dryer. The wood pieces may be dried under any suitable conditions (e.g., at a temperature of about 104° F. for about ten seconds or more), provided at least some of the water present is removed. Specifically, the wood pieces may be dried at about 150° F. to about 225° F. for about eight to ten minutes.

Although the step of moisture adjustment is described to include the use of one or more dryers, any suitable equipment may be used to adjust the moisture of the wood pieces. For example, the step may additionally, or alternatively, include the use of one or more moisture addition equipment.

Any suitable type of equipment may be used for the step of screening at 29. For example, rotating disk screens (with any suitable disks, such as triangular, square, rhombus, and/or rectangular shaped disks) rotary screens and inclined vibrating conveyors with screened sections may be used. Although the step of pieces preparation is shown to include the step of moisture adjustment and the step of screening, the step of pieces preparation may include any suitable step(s) configured to prepare the wood pieces for producing the engineered wood product. For example, the step of screening may additionally, or alternatively, include diverting higher quality pieces from lower quality pieces (determined by any suitable properties, such as piece length and/or width). The steps of pieces preparation may be performed in different sequences and in different combinations, not all steps being required for all embodiments of method 10.

The step of product formation at 16 may include one or more steps configured to produce an engineered wood product from the prepared wood pieces. For example, the step of product formation may include the steps of blending at 30, orienting at 32, preheating at 34, and curing at 36. The step of blending may be configured to contact at least part of one or more sets of the prepared wood pieces with one or more resins. For example, the step of blending at 30 may include the step of separating the wood pieces into two sets, the step of contacting at least part of a first set of wood pieces with a first resin, and the step of contacting at least part of a second set of wood pieces with a second resin. The first and/or second sets of wood pieces may include any suitable wood pieces. For example, the first and/or second set of wood pieces may include wood strands and/or wood flakes.

As used herein, “resin” may include an adhesive polymer of natural and/or synthetic origin. Any suitable resin(s) may be used in the blending step. For example, the resins may be thermoplastic polymers or thermosetting polymers. As used herein, “thermoplastic polymers” may include long-chain polymers that soften and flow on heating, and then harden again by cooling. Those polymers may generally have less resistance to heat, moisture, and long-term static loading than thermosetting polymers. Examples of resins that are based on thermoplastic polymers may include polyvinyl acetate emulsions, elastomerics, contacts, and hot-melts. As used herein, “thermosetting polymers” may undergo irreversible chemical change, and on reheating, may not soften and flow again. Those polymers may form cross-linked polymers that may have strength, may have resistance to moisture and other chemicals, and may be rigid enough to support high, long-term static loads without deforming. Examples of resins that are based on thermosetting polymers may include phenolic, resorcinolic, melamine, isocyanate, urea, and epoxy.

The resins may be of natural origin, synthetic origin, or may include a combination thereof. Resins of natural origin may include animal protein, blood protein, casein protein, soybean protein, lignocellulostic residue and extracts, bark-based resins, and combinations thereof. Resins of synthetic origin may include cross-linkable polyvinyl acetate emulsion, elastomeric contact, elastomeric mastic, emulsion polymer/isocyanate, epoxy, hot melt, isocyanate, formaldehyde, melamine and melamine urea, phenolic, polyvinyl acetate emulsion, polyurethane, resorcinol and phenol resorcinol, urea, and combinations thereof.

Specifically, the resins may include an isocyanate resin, a melamine resin, a phenol-formaldehyde (PF) resin, a melamine-formaldehyde (MF) resin, a phenol-melamine-formaldehyde (PMF) resin, a melamine-urea-formaldehyde (MUF) resin, a phenol-melamine-urea-formaldehyde (PMUF) resin, or a combination thereof. Examples of suitable isocyanate resins may include PMDI (polymethylene diphenyl diisocyanate); MDI (methylene diphenyl diisocyanate), or a combination thereof.

The phenols of the above resins may be substituted. Examples of suitable substituted phenols may include alkyl substituted phenols, aryl substituted phenols, cycloalkyl substituted phenols, alkenyl substituted phenols, alkoxy substituted phenols, aryloxy substituted phenols, and halogen substituted phenols, as disclosed in U.S. Pat. No. 5,700,587, the complete disclosure of which is hereby incorporated by reference for all purposes. Additional examples of suitable substituted phenols are disclosed in U.S. Pat. No. 6,132,549, the complete disclosure of which is hereby incorporated by reference for all purposes.

Additionally, or alternatively, the formaldehyde of the above resins may be replaced with another suitable aldehyde. Examples of suitable aldehydes include acetaldehyde, propionaldehyde, furfuraldehyde, and benzaldehyde. In general, the aldehyde employed may have the formula R′CHO wherein R′ is a hydrogen or a hydrocarbon radical of 1 to about 12 carbon atoms. Other examples of suitable aldehydes are disclosed in U.S. Pat. No. 5,700,587, the complete disclosure of which has been incorporated by reference for all purposes.

The resin may be a solid, such as a powder, a liquid, or a combination thereof. For example, the resin may be in at least substantially liquid form or the resin may be in at least substantially solid form. If the resin is a liquid, the liquid resin may be relatively viscous, relatively nonviscous, or somewhere in between. If the resin is a liquid and is relatively viscous, then the resin may be diluted with one or more carriers to render the resin relatively nonviscous. Examples of suitable carriers may include water, organic hydrocarbons, or a combination thereof.

Some of the resins described above may be more washout resistant than other resins. Thus, a blanket of oriented pieces formed from the wood pieces may be configured to at least substantially minimize washout of the resin by, at least in part, using resins that are more washout resistant than other resins. As used herein, “washout” may refer to loss of at least a portion of the resin during one or more steps of method 10 before the resin is cured, such as the preheating step at 34. As used herein, “washout resistant” or “washout resistance” may refer to characteristic(s) of the resin to remain at least in partial contact with the wood pieces and/or to resist washout before the resin is cured.

When steam is used during at least part of the preheating step, an isocyanate resin (such as MDI) may be more washout resistant than a PF resin. When MDI is used, one or more release agents may be used to minimize adherence of the wood pieces having MDI to one or more portions of the equipment used in method 10, such as the steel used in the presses of the step of curing. The release agent(s) may be mixed with the MDI and/or applied to surface(s) of the equipment.

Some of the resins described above may react with water and may thus be more washout resistant than other resins that do not react with water. For example, when steam is used during at least part of the preheating step, isocyanate resins may react with water, while PF resins may not react with water. Although isocyanate resins are discussed to be more washout resistant than PF resins, other resins also may be more washout resistant than PF resins and/or less washout resistant than isocyanate resins. Additionally, although isocyanate resins are discussed to react with water and PF resins are discussed to not react with water, other resins also may react with water and other resins may not react with water.

Additional examples of suitable resins may be found in the Handbook of Thermoset Plastics, Wood Handbook, sections 9-16, 9-9, 10-3, and 10-4; Forest Products Society Publications (http://www.forestprod.org); Wood Adhesives 2000, extended abstracts cat. No. 7260; International Contributions to Wood Adhesion Research, cat No. 7267; Wood Adhesives 1999, cat No. 7266; 1998 Resin Binding Seminar Proceedings, cat No. 7266; Handbook of Pressure Sensitive Adhesive Technology, 3^{rd} edition by Donatas Satas, Hardcover; Handbook of Adhesive Technology, by A. Pizzi, K. L. Mittal, Hardcover; Resin Transfer Moulding, by Kevin Potter, Hardcover; and Cyanoacrylate Resins: The Instant Adhesives, by Henry L. Lee, Paperback, T/C Press, January 1986; and references cited therein. The complete disclosures of the above references are hereby incorporated by reference for all purposes.

Additional examples of suitable resins may be found in U.S. Pat. Nos. 6,136,408; 6,132,885; 6,132,549; 6,028,133; 5,974,760; 5,951,795; 5,861,119; 5,714,099; 5,700,587; 5,635,118; 5,554,429; 5,552,095; 5,425,908; 4,758,478; 4,514,532; 4,407,999; 4,364,984; and references cited therein. The complete disclosures of the above patents are hereby incorporated by reference for all purposes.

In the example discussed above, at least part of the first set of wood pieces may be contacted with at least one PF resin, while at least part of the second set of wood pieces may be contacted with at least one isocyanate resin (or at least one MDI resin). The at least one PF resin may be in at least substantially liquid form or at least substantially solid form. Alternatively, the at least one PF resin may include one or more PF resins in at least substantially liquid form and one or more PF resins in at least substantially solid form.

Additionally, the first and/or second sets of wood pieces may be contacted with wax and/or other additives during the step of blending. For example, wax may be added to improve the efficiency of the resin(s) used and/or enhance the resistance of the blanket of oriented pieces to moisture and water absorption. Other additive(s) may additionally, or alternatively, be used to provide the engineered wood product with particular characteristics.

Although the first set of wood pieces is described to be contacted with at least one PF resin and the second set of wood pieces is described to be contacted with at least one isocyanate resin, the first and/or second sets of wood pieces may alternatively, or additionally, be contacted with one or more other suitable resins. For example, the first and/or the second sets of wood pieces may be contacted with a mixed media of two or more resins, such as a mixed media of a PF resin and a MDI resin. Additionally, although the first and second sets of wood pieces are discussed to be contacted with different resins, both sets of wood pieces may be contacted with the same resin. Moreover, although the prepared wood pieces are discussed to be separated into two sets of wood pieces, the prepared wood pieces may be separated into three or more sets of wood pieces, with those sets of wood pieces being contacted with one or more resins.

In some embodiments, the step of blending at 30 may include the step of applying at least one preservative on the prepared wood pieces, the step of applying at least one wax on the prepared wood pieces, and/or the step of applying at least one resin on the prepared wood pieces. The preservative, wax, and resin may be applied on any suitable portions of the wood pieces.

Preservatives may include any chemical added at any suitable step(s) of manufacturing engineered wood products to increase resistance of those products against pests or wood destroying organisms, decay, fires, etc. For example, preservatives may include pesticides, fungicides, insecticides, termiticides, and/or any combination of the above. The preservatives may include any suitable ingredients, including calcium borate, zinc borate, zinc napthenate, copper naphthenate, pyrethroids, tar acids, pentachlorophenol, tri-butyl tin oxide-lindanes, N-alkyl-N,N-dimethlyamine (ADO), 3-iodo-2-propynyl butyl carbamate (IPBC), ammonium phosphate, ammonium borate, diidomethyl-p-tolylsulfone (DIMTS), and/or imidacloprid. Other examples of preservatives are provided in U.S. Pat. Nos. 7,163,974; 7,008,684; 6,818,317; 6,811,731; 6,416,789; 6,403,000; 6,030,562; and 4,879,083; and U.S. Patent Application Publication Nos. 2007/0122644; 2007/0120284; 2007/0077445; 2006/0169431; and 2006/0145383. The complete disclosures of those patents and patent applications are herein incorporated by reference for all purposes.

Waxes may include any chemical added to improve the efficiency of the resin(s) used and/or enhance the resistance of the blanket of oriented pieces to moisture and water absorption. Any suitable wax(es) may be used in the manufacturing process, such as emulsion type waxes. Examples of waxes are disclosed in U.S. Pat. No. 6,830,614, the complete disclosure of which is herein incorporated by reference for all purposes.

The application of preservative, wax, and/or resin may be in any suitable form(s), such as via spraying, painting, etc. In some embodiments, the preservative and/or the wax may be applied on the wood pieces as drops and/or droplets of any suitable size(s). Additionally, or alternatively, the resin may be applied on the wood pieces as droplets of any suitable size(s).

In some embodiments, the application of preservative, wax, and/or resin on the wood pieces may be configured to prevent incompatibility and/or interference among those chemicals. “Incompatibility,” “incompatible,” “interference” or “interfering,” as used herein to describe the effect of a first chemical on a second chemical, refers when the first chemical, in the presence of a second chemical, changes one or more physical and/or chemical properties of the second chemical such that the second chemical cannot perform its intended function at the same dosage and/or same operating parameters that the second chemical typically performs its function without the presence of the first chemical. For example, the presence of a preservative may interfere with a resin's ability to cure and bond the blanket of wood pieces by changing the resin's pH, viscosity, cure speed, crosslink density, and/or boiling water gel time.

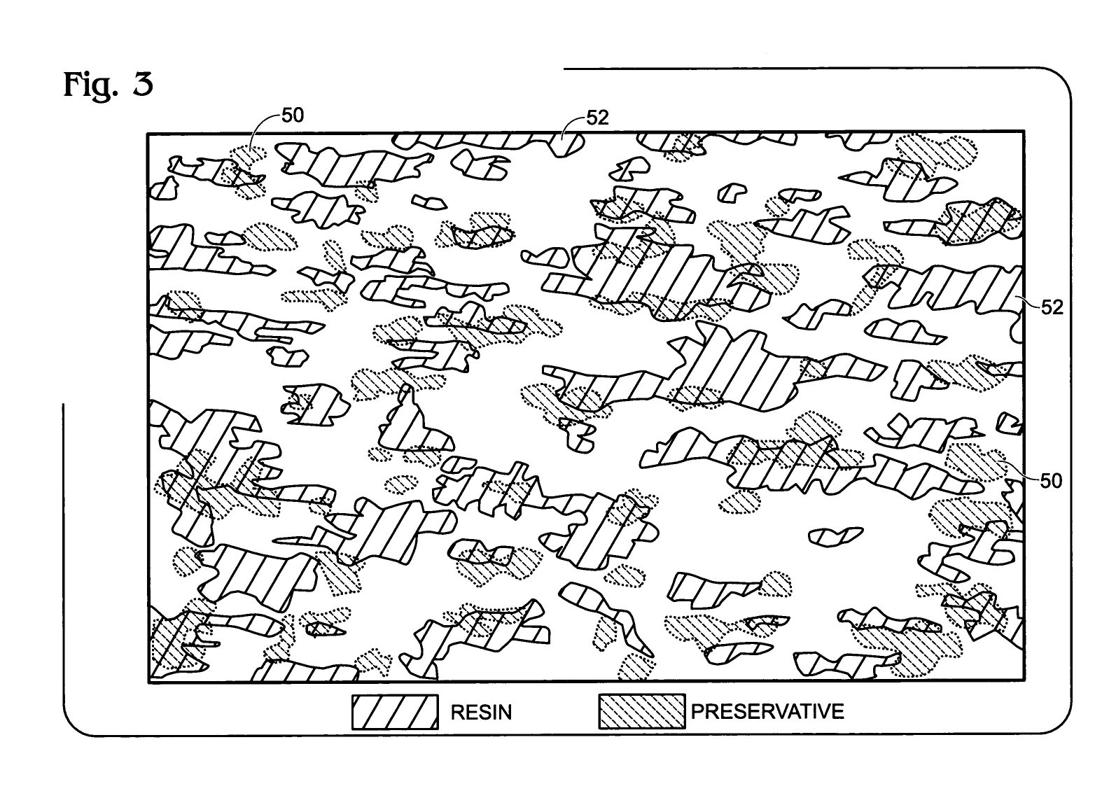

The application of preservative and/or resin may be configured to prevent the preservative from interfering and/or changing one or more chemical and/or physical properties of the resin, such as the resin's ability to cure during curing step 36, or vice-versa. For example, as shown in FIG. 3, the at least one preservative may be applied on one or more first portions 50 and the at least one resin may be applied on one or more second portions 52. In some embodiments, at least most of the one or more second portions may be different from, or on different locations or areas on the wood pieces as, the one or more first portions.

“Different,” as used herein, in reference to the first and second portions means that the first portions do not occupy the same areas on the wood piece as the second portions, even though there may be overlap(s) between those two areas. At least one wax may additionally, or alternatively, be applied on the one or more first portions (and/or on the one or more second portions). The application of the preservative and/or the wax on mostly different areas or locations on the wood piece than the application of the resin may prevent or minimize interference by the preservative and/or the wax (and/or prevent or minimize changing one or more chemical and/or physical properties of the resin).

In some embodiments, the step of blending at 30 may additionally, or alternatively, include mixing preservative(s) and wax(es) to form a mixture of preservative(s) and wax(es), and/or applying the mixture of preservative(s) and wax(es). The step of blending at 30 may alternatively, or additionally, include mixing preservative(s) and resin(s) to form a mixture of preservative(s) and resin(s), and/or applying the mixture of preservative(s) and resin(s). In some embodiments, premixed solutions of preservative(s) and wax(es) and/or premixed solutions of preservative(s) and resin(s) may be applied.

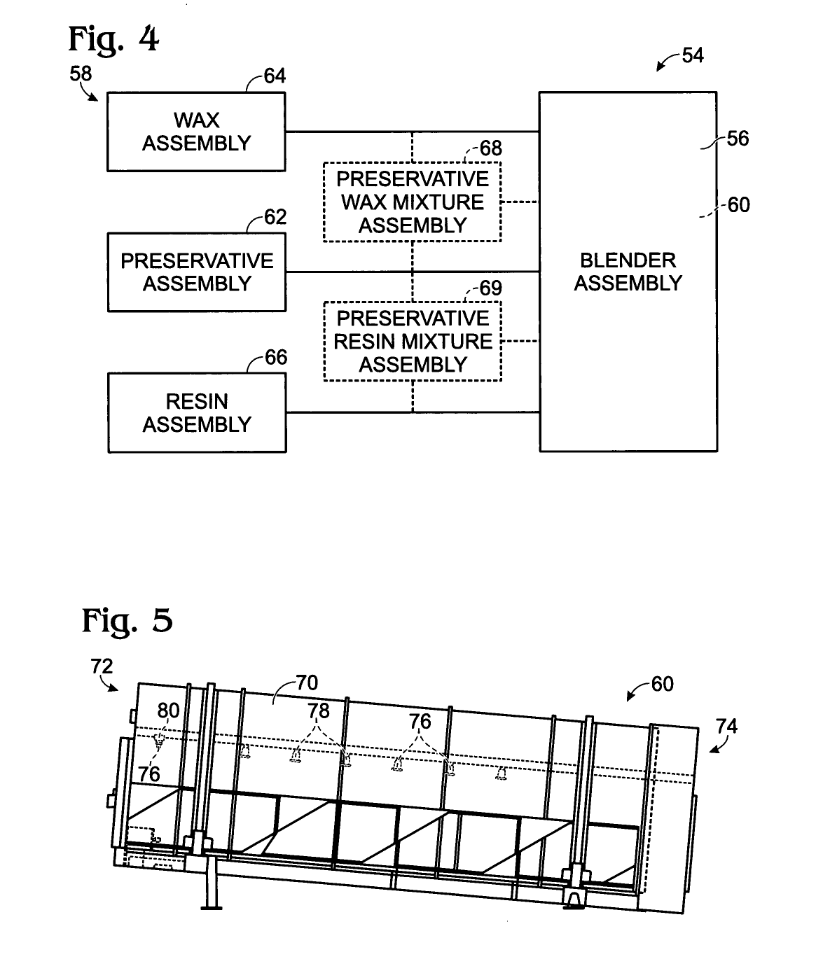

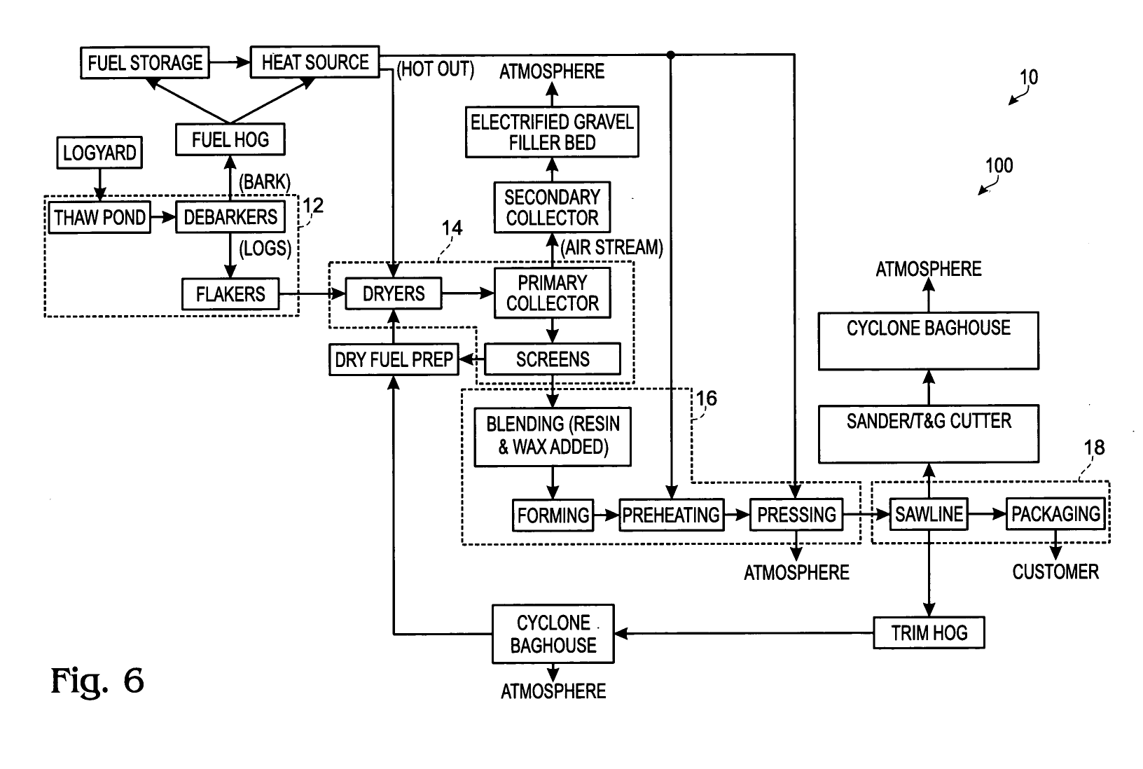

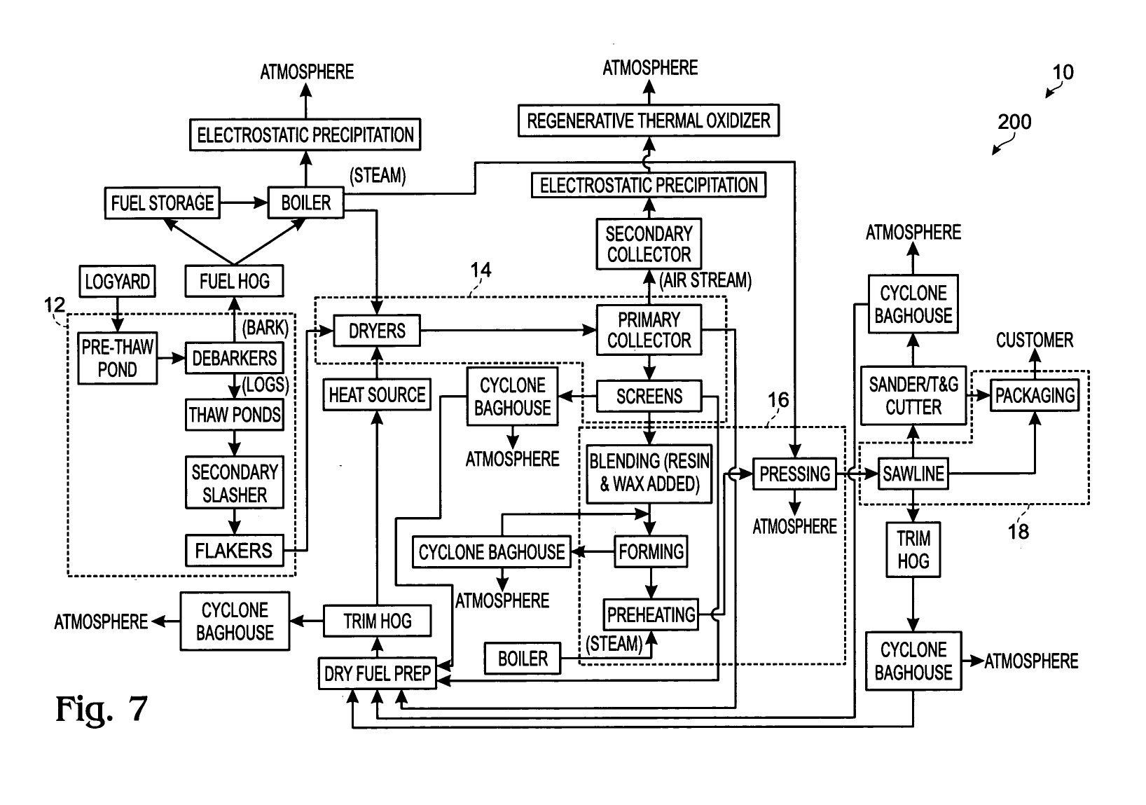

Any suitable equipment may be used to perform the step of blending, such as rotating blenders, spinning disk applicators, and/or other applicators. For example, as shown in FIG. 4, a blender and chemical assembly 54, which may include any suitable structure configured to at least partially perform the step of blending, may be used. The blender and chemical assembly may include a blender assembly 56 and one or more chemical assemblies 58.

The blender assembly may include any suitable structure configured to receive chemicals from one or more of the chemical assemblies and to apply those chemicals to the wood pieces. For example, blender assembly 56 may include one or more blenders 60, such as rotating blenders. Chemical assemblies 58 may include a preservative assembly 62, a wax assembly 64, and a resin assembly 66. Those assemblies may include any suitable structure fluidly connected to the blender assembly and configured to supply one or more preservatives, one or more waxes, and one or more resins, respectively, to the blender assembly. For example, those assemblies may include one or more tanks, containers, pumps, sensors, meters, etc.

In some embodiments, chemical assemblies 58 may include a preservative and wax mixture assembly 68. That assembly may be fluidly connected to the preservative and wax assemblies, and may be configured to mix one or more preservatives and one or more waxes to form a mixture of the preservatives and waxes and/or to store that mixture. Additionally, or alternatively, the preservative and wax mixture assembly may be configured to supply the mixture of the preservatives and waxes to the blender assembly. Preservative and wax mixture assembly 68 may include one or more mixers, tanks, containers, pumps, sensors, meters, etc.

In some embodiments, chemical assemblies 58 may alternatively, or additionally, include a preservative and resin mixture assembly 69. That assembly may be fluidly connected to the preservative and resin assemblies, and may be configured to mix one or more preservatives and one or more resins to form a mixture of the preservatives and waxes, and/or to store that mixture. Additionally, or alternatively, the preservative and resin mixture assembly may be configured to supply the mixture of the preservatives resins to the blender assembly. Preservative and resin mixture assembly 69 may include one or more mixers, tanks, containers, pumps, sensors, meters, etc.

Although chemical assemblies 58 are shown to include preservative assembly 62, wax assembly 64, resin assembly 66, preservative and wax mixture assembly 68, and preservative and resin mixture assembly 69, the chemical assemblies may include any suitable chemical assemblies. For example, chemical assemblies 58 may include only preservative and wax mixture assembly 68 and resin assembly 66. Alternatively, chemical assemblies 58 may include only wax assembly 64 and preservative and resin assembly 69.

FIG. 5 shows an example of blender 60, which may include at least one rotating drum 70 having an inlet 72 and an outlet 74, and one or more chemical applicators 76 disposed between the inlet and the outlet. Other examples of blenders are provided in U.S. Pat. Nos. 4,831,959 and 6,451,115, the complete disclosures of which are herein incorporated by reference for all purposes. Although blender 60 is shown to be a rotating blender, the blender may alternatively, or additionally, include other types of blenders.

The chemical applicators may include any suitable structure configured to apply one or more chemicals, such as preservative(s), wax(es), and/or resin(s), on the wood pieces. For example, the chemical applicators may include one or more atomizers 70 and one or more nozzles 80. Any suitable type(s) of atomizers may be used. Examples of atomizers are shown in U.S. Pat. No. 6,672,518 and U.S. Patent Application Publication No. 2003/0230639, the complete disclosures of which are herein incorporated by reference for all purposes. Additionally, nozzles 72 may include any suitable type of nozzles, such as convergent nozzles, divergent nozzles, high velocity nozzles, jet nozzles, spray nozzles, and/or shaping nozzles.

The blender may include any suitable number of atomizers 70 and/or nozzles 72 may be used. For example, rotating blender 60 may include six of the atomizers and a single nozzle (such as a jet nozzle), as shown in FIG. 5. Additionally, or alternatively, the atomizers and/or the nozzles may be in any suitable locations within the blender. For example, at least one nozzle may be positioned adjacent the inlet of the rotating drum, while the one or more atomizers may be positioned within the rotating drum in a spaced orientation between the inlet and the outlet of the blender, as shown in FIG. 5.

Specific nozzle(s) and/or atomizer(s) may be used for specific chemicals applied, or two or more of the chemicals may be applied by one or more of the nozzles and/or atomizers. For example, at least one preservative and/or at least one wax may be applied by at least one nozzle at adjacent to the inlet, and at least one resin may be applied by one or more atomizers. Alternatively, or additionally, one or more atomizers may apply the at least one preservative and/or the at least one wax.

Alternatively, at least one wax may be applied by a single nozzle and a mixture of at least one preservative and at least one resin may be applied by one or more atomizers. Additionally, or alternatively, at least one wax may be applied by at least one atomizer, and a mixture of at least one preservative and at least one resin may be applied by one or more of the other atomizers. Although blender 60 is shown to include a particular configuration of chemical applicators, the blender may include any suitable configuration of chemical applicators, which may include variations in number, type, position, type of chemical(s) applied, etc.

The step of forming or orienting the wood pieces at 32 may be configured to provide or form a mat or blanket of oriented pieces. The blanket of oriented pieces may have any suitable numbers and/or types of layers. For example, the blanket of oriented pieces may include a core layer sandwiched between a pair of face layers. Any suitable set or combination of sets of wood pieces from the blending step may be used to form one or more of the layers of the blanket of oriented pieces. For example, the core layer may be formed of the second set of wood pieces, while the pair of face layers may be formed of the first set of wood pieces.

Additionally, the wood pieces may be oriented in any suitable direction in each of the layers. For example, at least a substantial portion of the wood pieces of the core layer and the face layers may be oriented at least substantially lengthwise (or along the length of the engineered wood product). Alternatively, at least a substantial portion of the wood pieces of the core layer may be oriented at least substantially perpendicular to at least a substantial portion of the wood pieces of the face layers.

Moreover, the layers of the blanket of oriented pieces may have any suitable weight ratios to at least substantially minimize washout of the one or more resins, such as any suitable face-layers-to-core-layer weight ratio before the step of preheating. For example, the face-layers-to-core-layer weight ratio before the step of preheating may be based, at least in part, on a target thickness for the engineered wood product, a target density for the engineered wood product, preheating time, washout resistance of the resin used for the core layer, washout resistance of the resin used for the face layer(s), and/or other suitable factors. In some engineered wood products (such as oriented strand lumber and laminated strand lumber), the face-layers-to-core-layer weight ratio before steam preheating may range from about 5% to 95%, to about 40% to 60% to at least substantially minimize washout of the one or more resins. In some engineered wood products (such as oriented strand lumber and laminated strand lumber), the face-layers-to-core-layer weight ratio before steam preheating may range from about 11.4% to 88.6%, to about 21.2% to 78.8% to at least substantially minimize washout of the one or more resins.

Similarly, the layers of the blanket of oriented pieces may have any suitable weight per unit area to at least substantially minimize washout of the one or more resins, such as any suitable weight per unit area before the step of preheating. For example, one or both of the face layers may have a weight per unit area before the step of preheating based, at least in part, on a target thickness for the engineered wood product, a target density for the engineered wood product, preheating time, washout resistance of the resin used for the core layer, washout resistance of the resin used for the face layer(s), and/or other suitable factors. In some engineered wood products (such as oriented strand lumber and laminated strand lumber), the weight per unit area of one or each of the face layers may be about 0.2 to about 1.2 pounds per square foot (lbs/ft²) before the step of steam preheating to at least substantially minimize washout of the one or more resins. In some engineered wood products (such as oriented strand lumber and laminated strand lumber), the weight per unit area of one or each of the face layers may be about 0.27 to about 0.7 lbs/ft² before the step of steam preheating to at least substantially minimize washout of the one or more resins.

Any suitable equipment may be used for the step of orienting or forming the wood pieces. For example, orienting equipment may include disk-type and star-type orienters, and may range from electrostatic equipment to mechanical devices containing spinning disks, orienting disks, and/or other types of equipment to align wood pieces. Some equipment may use the dimensional characteristics of the wood pieces to achieve the desired alignment onto a moving caul plate or conveyor belt below forming heads. Oriented layers of wood pieces within the blanket may be dropped sequentially, each with a different forming head. Some equipment may use wire screens to carry the blanket into the press or screenless systems in which the blanket may lie directly on the conveyor belt.

Although the blanket of oriented pieces is described to include a core layer sandwiched between a pair of face layers, the blanket of oriented pieces may include any suitable number of layers. Additionally, although the blanket of oriented pieces is discussed to have certain face-layers-to-core-layer weight ratios or have layers with certain weight per unit area, the blanket of oriented pieces may have any suitable face-layers-to-core-layer weight ratio or have layers with any suitable weight per unit area configured to at least substantially minimize washout of the first resin. For example, the use of resin(s) in solid form and/or resin(s) that are more washout resistant may allow the blanket of oriented pieces to have one or both face layers with higher weights per unit area then described above. Moreover, although the layers of the blanket of oriented pieces is described to have at least a substantial portion of wood pieces oriented in specific orientations, those layers may include any suitable portion(s) of wood pieces oriented in any suitable orientation(s).

The step of preheating at 34 may be configured to preheat at least a portion of the blanket of oriented pieces. Preheating may facilitate or shorten time required for the step of curing, particularly for thicker engineered wood products, such as oriented strand lumber (OSL) and laminated strand lumber (LSL). Any suitable portion(s) of the blanket of oriented pieces may be preheated. For example, at least a substantial portion of the core layer may be preheated. Alternatively, at least a substantial portion of one or both of the face layers may be preheated. Alternatively, at least a substantial portion of the blanket of oriented pieces may be preheated.

Any suitable material(s) and/or equipment may be used to preheat. For example, steam at any suitable concentration may be injected and/or otherwise introduced to the blanket of oriented pieces. Preheating with steam (or steam preheating) may be performed for any suitable period of time to at least substantially minimize washout of the one or more resins. For example, the steam preheating may be performed for a sufficient period of time to raise the temperature of at least a substantial portion of the core layer to a target core temperature. The target core temperature may be based, at least in part, on a target thickness for the engineered wood product, a target density for the engineered wood product, washout resistance of the resin used for the core layer (such as the first resin in the example described above), washout resistance of the resin used for the face layer (such as the second resin in the example described above), and/or other suitable factors. For example, a target core temperature may be about 212° F. to about 221° F. In some blankets of oriented pieces, a sufficient period of time for the steam preheating may be about 20 seconds to about 70 seconds for the core layer to reach a target core temperature of about 212° F. to about 221° F. to at least substantially minimize washout of the one or more resins. In some blankets of oriented pieces, a sufficient period of time for the steam preheating may be about 30 seconds to about 32 seconds for the core layer to reach a target core temperature of about 212° F. to about 221° F. to at least substantially minimize washout of the one or more resins.

Any suitable equipment may be used to preheat the blanket of oriented pieces. For example, the preheating may at least substantially be performed in a continuous press where the step of curing also is performed. Alternatively, or additionally, the preheating may be performed in a separate preheater, and/or other suitable equipment.

Although the step of preheating is discussed to include steam injection or steam preheating, the step of preheating may include any suitable step(s) and/or any suitable equipment configured to preheat at least a portion of the blanket of oriented pieces. For example, hot air, radio frequency and/or microwave equipment may alternatively, or additionally, be used for the step of preheating. Additionally, although the step of preheating is discussed to include steam, the step of preheating may include any suitable material(s). For example, air and/or electromagnetic radiation may additionally, or alternatively, be used for the step of preheating.

Moreover, although the step of preheating is discussed to have particular target core temperatures and steam preheating times are discussed, the step of preheating may include any suitable target core temperature(s) and steam preheating time(s) to at least substantially minimize washout of the one or more resins. For example, varying one or more parameters of the method, such as the speed of the continuous press, may allow steam preheating times of less than 20 seconds or more than 70 seconds. Furthermore, although the step of preheating is described to be performed in a continuous press, the step of preheating may be performed via any suitable equipment, including any suitable type(s) of batch equipment.

The step of curing at 36 may include any suitable step(s) configured to cure the one or more resins, such as exposing at least a part of the blanket of oriented pieces to an elevated temperature, an elevated pressure, and/or radiant energy to cure the first and second resins. For example, hot pressing may be used to compress the blanket of oriented pieces under elevated temperature and elevated pressure to cure the one or more resins. Any suitable equipment may be used, such as multiple-opening or continuous presses, such as steam injection presses. For example, the step of curing may at least substantially be performed in a continuous press.

As used herein, “elevated temperature” may include any temperature above room temperature of 77° F. The elevated temperature may be above about 212° F., above about 302° F., above about 392° F., or up to about 482° F. Specifically, the elevated temperature may be about 77° F. to about 599° F., about 77° F. to 425° F., about 212° F. to about 425° F., or about 374° F. to about 425° F. More specifically, when the desired engineered wood product is an oriented strand board (OSB), the elevated temperature may be about 325° F. to about 475° F., may be about 350° F. to about 450° F., or about 375° F. to about 425° F. More specifically, when the desired engineered wood product is plywood, elevated temperature may be about 225° F. to about 425° F., about 250° F. to about 400° F., or about 275° F. to about 375° F. More specifically, when the desired engineered wood product is oriented strand lumber (OSL) or laminated strand lumber (LSL), elevated temperature may be about 257° F., or about 248° F. to 266° F.

As used herein, “elevated pressure” may include any pressure above standard pressure of 1 atmosphere (atm). Elevated pressure may be above about 5.0 atm, above about 10.0 atm, above about 20.0 atm, above about 40.0 atm, or above about 80.0 atm. Specifically, the elevated pressure may be about 60.0 atm to about 85.0 atm. More specifically, when the desired engineered wood product is OSB, then the elevated pressure may be about 25 atm to about 55 atm, about 30 atm to about 50 atm, about 34 atm to about 48 atm, or about 35 atm to about 45 atm. More specifically, when the desired engineered wood product is plywood, then the elevated pressure may be about 8.0 atm to about 21 atm or about 10.0 atm to about 17 atm. More specifically, when the desired engineered wood product is OSL or LSL, elevated pressure may be about 21.1 atm to about 40.8 atm, or about 8.2 atm to about 9.5 atm.

Although the step of curing is discussed to include the step exposing at least part of the blanket of oriented pieces to an elevated temperature, elevated pressure, and/or radiant energy, the step of curing may include any suitable step(s) configured to cure the one or more resins. Additionally, although specific elevated temperature and pressure ranges are provided, any suitable elevated temperatures and pressures may be used. Moreover, although specific elevated temperatures and pressure ranges are provided for OSB, plywood, OSL, and LSL, suitable elevated temperature and pressure ranges, which may be the same or different from the ranges discussed for OSB, plywood, OSL, and LSL, may be used for other desired engineered wood products.

Although the step of product formation at 16 is shown to include the steps of blending, forming, preheating, and curing, the step of product formation may include any suitable step(s) configured to form the desired engineered wood product from the prepared wood pieces. Additionally, the steps discussed above may be performed in different sequences and in different combinations, not all steps being required for all embodiments of method 10.

Product finishing at 18 may include one or more steps configured to finish the engineered wood product. For example, the product finishing may include the steps of cooling at 44, cutting to desired size(s) at 46, grade stamping at 48, stacking at 50. Although the step of product finishing at 18 is discussed to include particular step(s), the step of product finishing may include any suitable step(s) configured to finish the desired engineered wood product. For example, the step of product finishing may additionally, or alternatively, include grade stamping and/or edge coating. Additionally, the steps discussed above may be performed in different sequences and in different combinations, not all steps being required for all embodiments of method 10.

Method 10 may be carried out by one or more lines of equipment, which may be configured to produce one or more engineered wood products. For example, a first line of equipment may produce first engineered wood products, and a second line of equipment may produce second engineered wood products. In some embodiments, the two or more lines may share one or more pieces of equipment. In some embodiments, one or more portions of wood pieces may be diverted from one line to another line. For example, higher quality wood pieces may be diverted from other line(s) to one or more lines producing a higher quality engineered wood product. Quality of the wood pieces may be based on one or more suitable properties of the wood pieces, such as one or more physical dimensions.

Although method 10 is shown to include specific steps, the method may include any suitable step(s) configured to manufacture engineered wood product(s). Additional examples of method 10 are shown in FIGS. 3-4 and are generally indicated at 100 and 200, respectively. Another example is provided below.

### EXAMPLE

### Application of Wax/Preservative and Resin in Rotary Blender

Emulsion type wax and preservative containing about 3% imidacloprid was mixed to form a mixture of wax and preservative and then applied to the wood pieces through a jet nozzle at an inlet of a rotary blender. Additionally, liquid PF resin was applied to the wood pieces through the eight atomizers of the face blender. Additionally, liquid MDI resin was applied to the wood pieces through the six atomizers of the core blender. Typical wax and preservative dosage was about 0.78 to 1.30% of dry fiber basis, while typical resin dosage was about 4.70 to 4.98% of dry fiber basis. Average coverage by the mixture of the wax and preservative was about 6% (with an average spot size of about 0.0038 mm²) and the average coverage by the resin was about 30% (with an average spot size of about 0.0020 mm²). Average coverages were quantitatively measured by a computer image analyzer, which has been found to produce more accurate measurements than eyeball measurements.

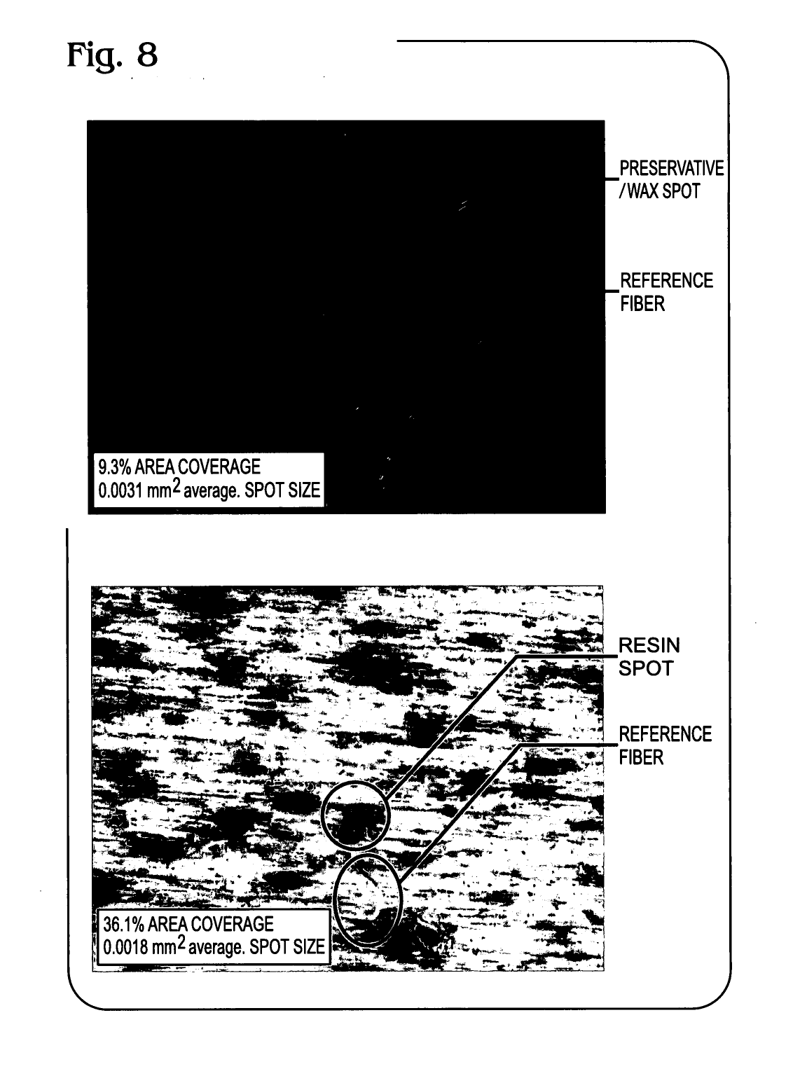

Images of a wood piece showing spots of resin and spots of a mixture of wax and preservative are shown in FIG. 8. A fluorescent dye was used to identify the mixture of wax and preservative spots. Additionally, a reference fiber was used to ensure that the same area of the wood piece was tested. There was no significant difference in structural soundness of the engineered wood products produced with the preservative as the engineered wood products formed without the preservative.

Although the methods of manufacturing engineered wood products and features of those methods have been shown and described with reference to the foregoing operational principles and preferred embodiments, those skilled in the art will find apparent that various changes in form and detail may be made without departing from the spirit and scope of the claims. The present disclosure is intended to embrace all such alternatives, modifications, and variances that fall within the scope of the appended claims.

What is claimed is:

1. A method of manufacturing an engineered wood product from a plurality of wood pieces, comprising:
applying at least one preservative on the plurality of wood pieces;
applying at least one resin on the plurality of wood pieces, wherein at least one of applying at least one preservative and applying at least one resin is configured to prevent interference among the at least one preservative and the at least one resin;
forming a blanket of wood pieces from the plurality of wood pieces; and
curing the at least one resin.

2. The method of claim 1, wherein applying at least one preservative includes applying at least one preservative on one or more first portions of the plurality of wood pieces, and applying at least one resin includes applying at least one resin on one or more second portions of the plurality of wood pieces, and wherein at least most of the one or more second portions are different from the one or more first portions.

3. The method of claim 1, wherein applying at least one preservative includes applying a mixture of the at least one preservative and wax.

4. The method of claim 3, wherein applying a mixture of the at least one preservative and wax includes mixing the at least one preservative and the wax to form the mixture of at least one preservative and wax.

5. The method of claim 1, wherein applying at least one preservative includes applying the at least one preservative as droplets on the plurality of wood pieces.

6. The method of claim 1, wherein the at least one preservative includes at least one termiticide.

7. The method of claim 6, wherein the at least one termiticide includes imidacloprid.

8. The method of claim 1, wherein applying at least one resin includes applying the at least one resin as droplets on the plurality of wood pieces.

9. The method of claim 1, wherein the at least one resin includes at least one phenol-formaldehyde (PF) resin.

10. The method of claim 9, wherein the at least one PF resin is in at least substantially liquid form.

11. The method of claim 1, wherein the at least one resin includes at least one methylene diphenyl diisocyanate (MDI) resin.

12. The method of claim 1, wherein the wood pieces include wood flakes.

13. A method of manufacturing an engineered wood product from a plurality of wood pieces, comprising:
applying a mixture of at least one preservative and wax on one or more first portions of the plurality of wood pieces;
applying at least one resin on one or more second portions of the plurality of wood pieces;
orienting the plurality of wood pieces to form a blanket of oriented pieces; and
curing the at least one resin.

14. The method of claim 13, further comprising mixing the at least one preservative and the wax to form the mixture of at least one preservative and wax.

15. The method of claim 13, wherein at least most of the one or more second portions are different from the one or more first portions.

16. The method of claim 13, wherein the at least one preservative includes at least one termiticide.

17. The method of claim 16, wherein the at least one termiticide includes imidacloprid.

18. The method of claim 13, wherein the at least one resin includes at least one phenol-formaldehyde (PF) resin.

19. The method of claim 13, wherein the at least one resin includes at least one methylene diphenyl diisocyanate (MDI) resin.

20. A method of manufacturing an engineered wood product from a plurality of wood pieces, comprising:
mixing at least one preservative and wax to form a mixture of at least one preservative and wax;
applying the mixture of at least one preservative and wax as droplets on one or more first portions of the plurality of wood pieces;
applying at least one of a PF resin and a MDI resin as droplets on one or more second portions of the plurality of wood pieces, wherein at least most of the one or more second portions are different from the one or more first portions;
orienting the plurality of wood pieces to form a blanket of oriented pieces; and
curing the at least one of a PF resin and a MDI resin.
